(19) United States
(12) Patent Application Publication
(10) Pub. No.: US 2004/0056704 A1
(43) Pub. Date: Mar. 25, 2004

(54) Apparatus for supplying high voltages with low power for solid state detectors and grids

(76) Inventor: Dean D. Aalami, Mission Viejo, CA (US)

Correspondence Address: Dean D. Aalami, Space Instruments, Suite 508, 19 Hammond, Irvine, CA, 92618-1636, US

(21) Appl. No.: 10/254,989

(22) Filed: Sep. 25, 2002

(51) Int. Cl. H02J 1/00

(52) U.S. Cl. 327/530

(57) ABSTRACT

A micro power, light weight, small size bias supply is achieved by combining a driver element, followed by an inductor, followed by a capacitive voltage multiplier stack. Performance is enhanced and reduction in components count is achieved by having multiple stages in series, output of each stage acting as input to the next stage. It is best suited for battery operated and space environments where low power consumption is essential.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of power supplies and more specifically to an apparatus for supplying high voltages with low power with high efficiency and minimal no load power to grids and solid state detectors. Grids are employed in scientific instruments for repulsion or acceleration of electrons and ions. A critical requirement for battery operated instruments or instruments operated in space environments is consumption of little power during standby and light load conditions. This invention leads to designs of grid supply voltages up to 500 volts with less than 1 millwatt of power consumption.

Solid state detectors are used for detection of particles, ions and radiation from nuclear materials. They also require bias supplies ranging from a few volts to over 500 volts with very little load currents. The present invention enables design of power supplies for these detectors with power consumption as little as a milliwatt.

State of the art power supplies, on the other hand, require hundreds of milliwatts during no load and as a consequence higher power consumption under loads. A typical state of the art power supply from a leading power supply producer lists the following currents for 200/2000V, 1 Waft power supply: no load current around 80 ma and full load current around 200 ma at input voltage of 10 to 15 V.

### OBJECTS OF THE INVENTION

The primary object of the invention is to provide an improved power supply for grids and solid state detectors with as little power consumption as a few milliwatts. Another object of the invention is to minimize excessive current surges in the multiplier section hence resulting in reduced electromagnetic emissions and improved electromagnetic compatibility, and a highly efficient power supply.

### BRIEF SUMMARY OF THE INVENTION

The basic element of the apparatus consists of a driver, typically a complementary arrangement, an inductor and a voltage multiplier stack configuration. The elements may be repeated for higher voltages and a judicial combination of the voltage multiplier stack and a multiplicity of the elements provides the designer flexibility and means to achieve high voltage and low power requirements.

The driver acts as a buffer for the input square wave signal. The inductor limits the rate of change of current through the capacitors of the multiplier stack thus improving electromagnetic compatibility and reducing power losses. With an appropriately designed value for the inductor and the frequency of the input square waveform, an efficient discontinuous mode of operation can be achieved whereby the charging current through the inductor will be effectively zero when the driver elements are changing states. This leads to reduced switching losses.

### BRIEF DESCRIPTION OF THE DRAWINGS

FIG. 1 is a simplified diagram of the apparatus. A two stage unit is shown with each stage consisting of a driver, an inductor and a multiplier stack.

Proceeding to the description of the first stage, its driver consists of capacitors C1 and C2, resistors R1 and R2, and complementary pair of high speed, high voltage MOSFET transistors. The input signal, indicated by E1, is a square wave signal coupled to the MOSFET devices through the capacitors. When E1 is high, M1 is turned on and M2 off, and when E1 is low, M1 is off and M2 is on. Waveform E2 is similar to E1 but the levels are constrained to be between zero and V1.

Inductor L1 ensures a smooth and slow build up of voltages across C3 and C4 in the multiplier stack reducing electromagnetic emissions and power losses associated with high current surges in its absence. Node 8 is connected to V1 to gain additional voltage at node 9 equal to v1 volts in amplitude. The second stage is similarly constructed with a driver, inductor and multiplier stack. The differences are that the output voltage of the first stage is connected to the driver of the second stage as indicated in the figure and the output of the driver is connected through inductor L2 to capacitor C9.

The figure also shows the feedback arrangement to generate an error signal for a stable power supply. Since this art is well known and does not constitute the present invention, it will not be described henceforth.

### DESCRIPTION OF THE INVENTION

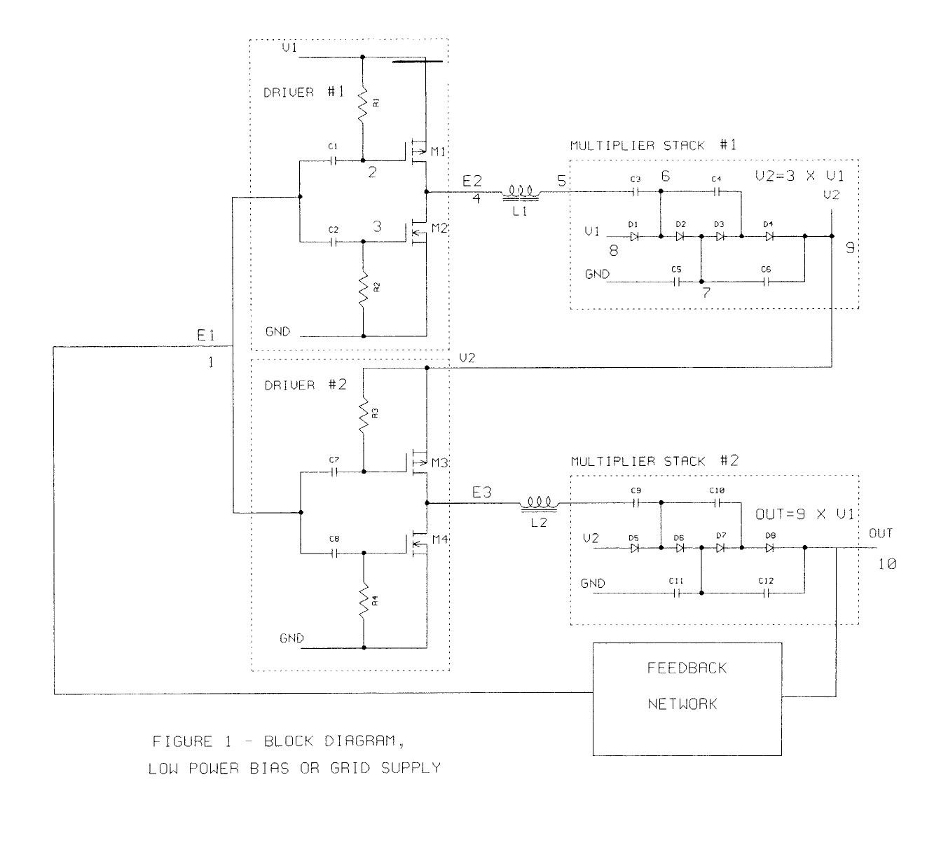

The invention will be described through an example of a circuit realization which is shown In FIG. 1. The square waveform generated by driver D1 with amplitudes between V1 and zero will develop a voltage of 3 times V1 at node 9. Since the input to driver D2 is 3 times V1, the multiplier stack in the second section will amplify to 9 times V1 at node 10.

### DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the important features of the present invention, FIG. 1 shows the cascading arrangement of two multiplier sections with individual driver elements and inductors appropriately placed to achieve a voltage multiplication factor of 9 and low power loss and electromagnetic emanations. The variations of the scheme can lead to different multiplication factors within each multiplier section and number of sections in the cascading chain.

The important feature of the invention is to include the inductor L1 between the driver circuit and the multiplier section. The second feature is the cascading of multiple stages with the output of the preceding stage used as the input to the driving element of the succeeding stage. The third feature is the connection of the driver DC voltage to the anode of the first diode in the multiplier stack. As a consequence, the output voltage of the multiplier stage is increased by a value equivalent to the DC voltage. This has the benefit of reducing the number of stages needed for gaining the required voltage amplification and improving the efficiency by reducing the required components.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An arrangement for supplying power to solid state detectors and grids that require low power comprising:
a driver, inductor and multiplier stage for each section;
a cascade of sections

2. Placement of the inductor in said arrangement before the capacitive multiplier stage to reduce emanations for improved electromagnetic compatibility.

3. A cascading arrangement of the multiple stages of driver, inductor and multiplier sections with their output voltages connected to the driver elements of the succeeding stages.

4. Connection in the said arrangement of claim 1 of the input DC voltage to the multiplier section to achieve an additional gain in voltage multiplication.
